(19) United States
(12) Patent Application Publication
(10) Pub. No.: US 2002/0173426 A1
(43) Pub. Date: Nov. 21, 2002

(54) Dip coating of phase pure YBCO films on substrates

(76) Inventor: Christine L. Vrtis, Carpentersville, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/800,051

(22) Filed: Mar. 6, 2001

(51) Int. Cl. H01B 1/00

(52) U.S. Cl. 505/100

(57) ABSTRACT

A method for providing a superconductive coating on substrates by dip coating is disclosed. The dip coating formulation includes a vehicle of terpineol, butoxyethyl acetate and binder which is mixed with phase pure YBCO powder to form an ink having a viscosity ranging from 220 cPs to about 270 cPs at 100 s⁻¹. After the substrate is dipped in the dip coating ink, it is dried and sintered. The ink formulation is prepared by dissolving the binder in the terpineol and butoxyethyl acetate solvents to create a vehicle. The phase pure YBCO powder is then mixed with the vehicle to create a dip ink formulation having the aforenoted viscosity.

### FIELD OF THE INVENTION

The present invention relates generally to superconducting materials, and more particularly to methods of manufacturing structures coated with high-temperature superconducting materials. Still more specifically, the present invention relates to manufacturing structures with high-temperature superconducting coatings using a dip coating process.

### BACKGROUND OF THE DISCLOSURE

The discovery that certain ceramic materials exhibit superconductivity at above liquid nitrogen temperatures has stimulated intensive research. Once such ceramic material is YBa₂Cu₃O₆₊ₓ where x ranges from 0 to 1 or “YBCO.” Many uses for such materials have been suggested and attempted, including, for example, devices operating with microwave or radio frequency signals such as antennas, magnetic resonance imaging pickup coils, resonators, and the like. Optimal performance of such devices may depend upon having the lowest possible surface resistance.

Low-surface resistance high-temperature superconducting materials have been successfully fabricated in the form of thin films of ceramic. Such films typically have a thickness on the order of 50 μm to 200 μm and are formed by depositing the ceramic material or its precursors on the surface of a planar, single crystal substrates using techniques such as co-evaporation, sputtering, laser ablation, and molecular beam epitaxy. The disadvantages of these techniques are discussed in U.S. Pat. Nos. 5,789,347 and 6,119,025 which disclose a “melt processing” process.

The melt processing process of the '347 and '025 patents involves heating a film that contains YBCO starting materials or precursor materials on a yttria/zirconia ceramic substrate at a temperature above 1015° C. in pure oxygen. The film is applied by doctor blading. The heat treatment is fast and relatively simple, but it cannot be used on metallic substrates due to the extreme temperatures (>1015° C.) required to generate the YBCO in the film. The typical surface resistance of the flat films produced by the melt texture process of the '347 and '025 patents are about 0.1 milliohms while the surface resistance of small diameter curved surfaces, e.g., 1-3 mm diameter, is somewhat higher, about 0.3 milliohms.

U.S. Pat. Nos. 5,340,797 and 5,527,765 disclose a “reactive texture” process which involves forming films on metallic substrates from compounds containing constituents of YBCO. The substrate and films are then heated to near 900° C. which results in a decomposition of the compounds containing constituents of YBCO and the crystallization of YBCO or the substrate. Substrates are typically stainless steel or INCONEL™ (a.k.a. PYROMET™) which require thick silver plating before the application of the YBCO film. The heat treatment requires multiple gas changes including a warm-up in carbon dioxide. The dwell is typically performed in a 2 Torr oxygen atmosphere, but it is claimed to work in higher oxygen concentrations all the way up to pure oxygen. The process is very sensitive and can be difficult to control. The films are applied by doctor blading, screen printing, and spin coating.

U.S. Pat. No. 5,856,277 discloses a “surface texture” process which is a way to alter the surface of a bulk pellet of YBCO. The top layer of the resulting structure is typically much thicker than the film produced in the melt texture, surface texture and reactive texture processes discussed above.

The melt process, surface texture and reactive texture processes all utilize some degree of melting and recrystallization. The YBCO grain size in the surface texture process of the '277 patent is typically somewhat smaller than that of the melt process and reactive texture processes, but the surface resistance is about the same as in the other two texturing methods.

Conventional sinter processes use the same substrates and temperatures as the reactive texture process of the '797 and '765 patents but such conventional sinter processes use only phase-pure YBCO and do not involve melting any portion of the film. There is a single gas change at the end of the dwell time at maximum temperature when oxygen concentration is switched from a 1% oxygen atmosphere to a pure oxygen atmosphere. Conventional sinter processes are typically easy to perform but result in films with a resistivity that is significantly higher than that obtained by the melt texture, reactive texture and surface texture processes. However, the surface resistance provided by the conventional sinter processes is superior to that of ordinary conductors such as copper or silver, even at 77° K. Unlike the melt texture, reactive texture and surface texture processes, the YBCO grains produced by the conventional sintering processes are microscopic and randomly oriented, thus resulting in higher surface resistance.

The '347, '025, '797, '765 and '277 patents are all owned by the assignee of the present application and the disclosures of said patents are incorporated herein by reference.

To date, a dip coating process has not been developed which provides a superconductive coating with a satisfactory resistance that can be applied by a dip coating the substrate into a formulation or “ink.” The development of a dip coating technique would greatly facilitate the fabrication of substrates coated with a superconducting material thereby lowering the cost of products with superconductive coatings.

The creation of a suitable dip coating ink formulation is particularly problematic because the ink must not have a rapid evaporation rate and the resultant coating must be strong enough for subsequent handling. Currently, there are no available inks which have a suitably high viscosity rate for a sufficiently thick or strong coating in combination with a low evaporation rate. Further, a dip coating ink formulation must be able to stay in suspension so that the solids do not settle out during a production shift, such as an eight hour period.

### SUMMARY OF THE DISCLOSURE

The present invention satisfies the aforenoted need by providing a formulation for dip coating an unreacted superconducting coating on a substrate. The formulation comprises terpineol, butoxyethyl acetate, one or more binders and phase pure YBa₂Cu₃O₆₊ₓ powder.

In a further refinement, the present invention provides a formulation for dip coating a superconducting coating on a substrate that comprises: a vehicle comprising from about 57 wt % to about 59 wt % terpineol, from about 37 wt % to about 39 wt % butoxyethyl acetate, and from about 2 wt % to about 5 wt % binder; the vehicle is mixed with phase pure YBa₂Cu₃O₆₊ₓ powder so that the formulation comprises from about 62 wt % to about 64 wt % phase pure YBa₂Cu₃O₆₊ₓ powder, and from about 36 wt % to about 38 wt % vehicle.

In another refinement, the present invention provides a method for applying a superconducting coating onto a substrate which comprises providing a dip coating formulation that comprises phase pure YBa₂Cu₃O₆₊ₓ powder and a vehicle that comprises terpineol, butoxyethyl acetate and binder, dipping the substrate in the dip coating formulation, removing the substrate from the dip coating formulation, drying the substrate and sintering the substrate.

In a further refinement, the present invention provides a method for applying a superconducting coating onto a substrate by dip coating. The method comprises providing a substrate having a first thickness, providing a vehicle that comprises from about 57 wt % to about 59 wt % terpineol, from about 37 wt % to about 39 wt % butoxyethyl acetate and from about 2 wt % to about 5 wt % binder. The method further comprises mixing the vehicle with phase pure YBa₂Cu₃O₆₊ₓ powder to provide a formulation comprising from about 62 wt % to about 64 wt % phase pure YBa₂Cu₃O₆₊ₓ powder and from about 37 wt % to about 39 wt % vehicle followed by dipping the substrate in the dip coating formulation to form a coating thereon that has a second thickness, removing the substrate from the dip coating formulation, drying the substrate and sintering the substrate.

In a further refinement, the method comprises measuring the thickness of the coating after the drying step and, if the coating thickness is unsatisfactory, removing the coating and starting the process again.

In yet another refinement, the method comprises measuring the thickness of the coating after the sintering step and, if the thickness of the coating is unsatisfactory, removing the coating from the substrate and starting the process again.

In a further refinement, the vehicle viscosity is controlled to arrange from about 50 cPs to about 75 cPs at 100 s⁻¹.

In still a further refinement, the vehicle viscosity is about 68 cPs at 100 s⁻¹.

In another refinement, the dip coating formulation has a viscosity ranging from about 220 cPs to about 270 cPs at 100 s⁻¹.

In still a further refinement, the dip coating formulation has a viscosity of about 247 cPs at 100 s⁻¹.

### DETAILED DESCRIPTION OF THE PRESENTLY PREFERRED EMBODIMENTS

The formulation for dip coating substrates, including three dimensional substrates and other substrates, includes a vehicle mixed with phase pure YBCO powder so that the formulation comprises from about 62 wt % to about 64 wt % phase pure YBCO powder and from about 36 wt % to about 38 wt % of a vehicle. The vehicle comprises from about 57 wt % to about 59 wt % terpineol, from about 37 wt % to about 39 wt % butoxyethyl acetate and from about 2 wt % to about 5 wt % binder. The terpineol and butoxyethyl acetate serve as solvents. The terpineol is preferably alpha-terpineol and the butoxyethyl acetate is preferably 2-butoxyethyl acetate. The preferred binders are acryloid, more preferably B-67™ acryloid and cellulose, more preferably a combination of T-200™ cellulose, N4™ cellulose and Ehec-Hi™ cellulose. Preferably, the vehicle and the dip coating formulation are free of dispersants as they are deemed unnecessary.

One preferred formulation is as follows:

| | Preferred Weight % |
|---|---|
| Vehicle | |
| Alpha-terpineol | 57.85 |
| 2-Butoxyethyl acetate (a.k.a. “BCA”) | 38.61 |
| B-67 ™ acryloid (a.k.a. “paraloid”) | 1.58 |
| T-200 ™ ethylcellulose | 0.65 |
| Ehec-Hi ™ cellulose | 0.59 |
| N4 ™ cellulose | 0.72 |
| Dip Coating of Ink Formulation | |
| Phase pure YBa₂Cu₃O₆₊ₓ powder | 63 |
| Vehicle | 37 |

Generally, the solvents content control the viscosity. Accordingly, when alpha-terpineol is chosen as a solvent, if too much alpha-terpineol is provided, the ink formulation can be too thin, resulting in a film that is too thin. If an insufficient amount of alpha-terpineol is provided, the ink formulation can be too viscous resulting in a film that is too thick. Similarly, if butoxyethyl acetate is chosen as a solvent, if too much butoxyethyl acetate is provided, the ink formulation can be too thin, resulting in a film that is too thin. If an insufficient amount of butoxyethyl acetate is provided, the ink formulation can be too viscous resulting in a film that is too thick.

If the binder or binders are present in too great of an amount, the resulting ink formulation is too viscous and the resulting film can be too thin. If the binder or binders are present in an insufficient amount, the unfired film is too weak resulting in poor adhesion to the substrate.

Accordingly, when T-200™ ethylcellulose is chosen as a binder, if the T-200™ ethylcellulose is present in too great of an amount, the resulting ink formulation is too viscous and the resulting film can be too thin. If the T-200™ ethylcellulose is present in an insufficient amount, the unfired film is too weak resulting in poor adhesion to the substrate.

When N4™ cellulose is chosen as a binder, if the N4™ cellulose is present in too great of an amount, the resulting ink formulation is too viscous and the resulting film can be too thin. If the N4™ cellulose is present in an insufficient amount, the unfired film is too weak resulting in poor adhesion to the substrate.

When Ehec-Hi™ cellulose is chosen as a binder, if the Ehec-Hi™ cellulose is present in too great of an amount, the resulting ink formulation is too viscous and the resulting film can be too thin. If the Ehec-Hi™ cellulose is present in an insufficient amount, the unfired film is too weak resulting in poor adhesion to the substrate.

Similarly, if too much vehicle is added to the dip coating formulation, the resultant ink or formulation is too thin and the viscosity can be unsatisfactorily low, thereby resulting in a coating that is too thin. If the vehicle is added in an insufficient amount, the resultant formulation or ink is too thick, resulting in a coating that can be unacceptably thick.

If the phase pure YBCO powder is present in too great of an amount, the resultant ink formulation can be too viscous resulting in an unfired film that is weak. If the phase pure YBCO powder is present in an insufficient amount, the ink can be too thin or have an insufficient viscosity resulting in a fired film that is too thin.

Combinations of other solvents in addition to alpha-terpineol and butoxyethyl may also be utilized. Binders other than B-67™ acryloid, T-200™ ethylcellulose, N4™ cellulose and Ehec-Hi™ cellulose may also be utilized.

In creating the vehicle, the solids, i.e., the B-67™ acryloid, T-200™ ethylcellulose, N4™ cellulose and Ehec-hi™ cellulose are dissolved in the alpha-terpineol and 2-butoxyethyl acetate. Then, the phase pure YBCO powder is mixed with the resulting vehicle to produce an ink. A substrate, such as a silver plated PYROMET™ (INCONEL™ 600™) substrate, is then dipped into the dip ink formulation, removed and dried. The drying process can be carried out a temperature of about 90° C. During the drying process, the substrate can be rotated. Finally, the substrate is sintered. The sintering is carried out by heating the substrate at a rate of about 300° C. per hour to a temperature of about 840° C. and holding the substrate at that first temperature for about one hour. The heating and holding steps are preferably carried out in a 1% oxygen atmosphere. The substrate is then cooled at a rate of about 300° C. per hour to a temperature of about 700° C. in a pure oxygen atmosphere followed by further cooling at a rate of about 60° C. per hour to a temperature of about 300° C., again in a pure oxygen atmosphere, followed by faster cooling at a rate of about 300° C. per hour to room temperature, again in a pure oxygen atmosphere.

A preferred viscosity range for the vehicle is from about 50 cPs to about 75 cPs at 100 s⁻¹, preferably about 68 cPs at 100 s⁻¹. The viscosity of the resulting dip coating formulation or ink preferably ranges from about 200 cPs to about 270 cPs at 100 s⁻¹, preferably about 247 cPs at 100 s⁻¹. The viscosity measurements were made with a BROOKFIELD™ viscometer.

Three different phase pure YBCO powders are currently preferred. Two powders are supplied by Praxair, Inc. (Praxair phase pure with a d50<4.1 and Praxair phase pure with a d50<2). Another phase pure YBCO powder is provided by Marketech International, Inc.

The foregoing detailed description has been given for clearness of understanding only, and no unnecessary limitations should be understood therefrom, as modifications would be obvious to those skilled in the art.

What is claimed:

1. A formulation for dip coating a superconducting coating onto a substrate, the formulation comprising:
from about 62 to about 64 wt % phase pure YBa₂Cu₃O₆₊ₓ powder and from about 36 to about 38 wt % vehicle,
the vehicle comprising
from about 57 wt % to about 59 wt % terpineol,
from about 37 wt % to about 39 wt % butoxyethyl acetate, and
from about 2 wt % to about 5 wt % binder.

2. The dip coating formulation of claim 1 wherein the terpineol is further characterized as being alpha-terpineol.

3. The dip coating formulation of claim 1 wherein the butoxyethyl acetate is further characterized as being 2-butoxyethyl acetate.

4. The dip coating of claim 1 wherein the binder comprises acryloid and cellulose.

5. The dip coating formulation of claim 4 wherein the acryloid is further characterized as being B-67™ acryloid and is present in the vehicle in an amount ranging from about 1 wt % to about 2 wt %.

6. The dip coating formulation of claim 4 wherein the cellulose is further characterized as being a mixture comprising T-200™ cellulose present in the vehicle in an amount ranging from about 0 wt % to about 1 wt %, N4™ cellulose present in the vehicle in an amount ranging from about 0 wt % to about 1 wt % and Ehec-Hi™ cellulose present in the vehicle in an amount ranging from about 0 wt % to about 1 wt %.

7. The dip coating formulation of claim 1 wherein the formulation is free of dispersant.

8. The dip coating formulation of claim 1 wherein the vehicle comprises about 57.8 wt % terpineol.

9. The dip coating formulation of claim 3 wherein the vehicle comprises about 38.6 wt % 2-butoxyethyl acetate.

10. The dip coating formulation of claim 5 wherein the vehicle comprises about 1.6 wt % B-67™ acryloid.

11. The dip coating formulation of claim 6 wherein the vehicle comprises 0.6 wt % T-200™ cellulose.

12. The dip coating formulation of claim 1 wherein the terpineol is further characterized as being alpha-terpineol and is present in the vehicle in an amount of about 57.8 wt %.

13. The dip coating formulation of claim 1 wherein the butoxyethyl acetate is further characterized as being 2-butoxyethyl acetate and is present in the vehicle in an amount of about 38.6 wt %.

14. The dip coating formulation of claim 4 wherein the acryloid is further characterized as being B-67™ acryloid and is present in the vehicle in an amount of about 1.58 wt %.

15. The dip coating formulation of claim 4 wherein the cellulose is further characterized comprising a mixture of T-200™ cellulose present in the vehicle in an amount of about 0.65 wt %, Ehec-Hi™ cellulose present in the vehicle in an amount of about 0.59 wt % and N4™ cellulose present in the vehicle in an amount of about 0.72 wt %.

16. The dip coating formulation of claim 4 wherein the binder is present in the vehicle in an amount ranging from about 3 wt % to about 4 wt %.

17. The dip coating formulation of claim 4 wherein the binder is present in the vehicle in an amount of about 3.54 wt %.

18. The dip coating formulation of claim 1 wherein the vehicle has a viscosity ranging from about 50 cPs to about 75 cPs at about 100 s⁻¹.

19. The dip coating formulation of claim 1 wherein the vehicle has a viscosity of about 68 cPs at about 100 s⁻¹.

20. The dip coating formulation of claim 1 wherein the formulation has a viscosity ranging from about 220 cPs to about 270 cPs at about 100 s⁻¹.

21. The dip coating formulation of claim 1 wherein the formulation has a viscosity of about 247 cPs at about 100 s⁻¹.

22. A method for applying a superconducting coating onto a substrate by dip coating, the method comprising:
providing a substrate with a first thickness;
providing a vehicle comprising
from about 57 wt % to about 59 wt % terpineol,
from about 37 wt % to about 39 wt % butoxyethyl acetate, and
from about 2 wt % to about 5 wt % binder
mixing the vehicle with phase pure YBa₂Cu₃O₆₊ₓ powder to provide a dip coating formulation comprising from about 62 wt % to about 64 wt % phase pure YBa₂Cu₃O₆₊ₓ powder and from about 36 wt % to about 38 wt % vehicle;
dipping the substrate in the dip coating formulation to form a coating thereon having a second thickness;
removing the substrate from the dip coating formulation;
drying the substrate; and
sintering the substrate.

23. The method of claim 22 further comprising measuring the thickness of the coating after the drying step.

24. The method of claim 22 further comprising measuring the thickness of the coating after the sintering step.

25. The method of claim 22 further comprising measuring the first thickness of the substrate before the dipping step and measuring the second thickness of the coating after the drying step and, if the second thickness of the coating is unsatisfactory, removing the coating from the substrate and performing the method again.

26. The method of claim 22 further comprising measuring the first thickness of the substrate before the dipping step and measuring the second thickness of the coating after the sintering step and, if the thickness of the coating is unsatisfactory, removing the coating from the substrate and performing the method again.

27. The method of claim 22 further comprising measuring the first thickness of the substrate before the dipping step, measuring the second thickness of the coating after the baking step, measuring the second thickness of the coating after the sintering step and, if the thickness of the coating is unsatisfactory after either the baking or sintering steps, removing the coating from the substrate and performing the method again.

28. The method of claim 22 wherein the terpineol is further characterized as being alpha-terpineol.

29. The method of claim 22 wherein the butoxyethyl acetate is further characterized as being 2-butoxyethyl acetate.

30. The dip coating of claim 22 wherein the binder comprises acryloid and cellulose.

31. The method of claim 30 wherein the acryloid is further characterized as being B-67™ acryloid and is present in the vehicle in an amount ranging from about 22 wt % to about 2 wt %.

32. The method of claim 30 wherein the cellulose is further characterized as being a mixture comprising T-200™ cellulose present in the vehicle in an amount ranging from about 0 wt % to about 22 wt %, N4™ cellulose present in the vehicle in an amount ranging from about 0 wt % to about 22 wt % and Ehec-Hi™ cellulose present in the vehicle in an amount ranging from about 0 wt % to about 22 wt %.

33. The method of claim 22 wherein the formulation is free of dispersant.

34. The method of claim 22 wherein the vehicle comprises about 57.8 wt % terpineol.

35. The method of claim 29 wherein the vehicle comprises about 38.6 wt % 2-butoxyethyl acetate.

36. The method of claim 31 wherein the vehicle comprises about 1.6 wt % B-67™ acryloid.

37. The method of claim 32 wherein the vehicle comprises 0.6 wt % T-200™ cellulose.

38. The method of claim 22 wherein the terpineol is further characterized as being alpha-terpineol and is present in the vehicle in an amount of about 57.8 wt %.

39. The method of claim 22 wherein the butoxyethyl acetate is further characterized as being 2-butoxyethyl acetate and is present in the vehicle in an amount of about 38.6 wt %.

40. The method of claim 30 wherein the acryloid is further characterized as being B-67™ acryloid and is present in the vehicle in an amount of about 1.58 wt %.

41. The method of claim 30 wherein the cellulose is further characterized comprising a mixture of T-200™ cellulose present in the vehicle in an amount of about 0.65 wt %, Ehec-Hi™ cellulose present in the vehicle in an amount of about 0.59 wt % and N4™ cellulose present in the vehicle in an amount of about 0.72 wt %.

42. The method of claim 30 wherein the binder is present in the vehicle in an amount ranging from about 3 wt % to about 30 wt %.

43. The method of claim 30 wherein the binder is present in the vehicle in an amount of about 3.54 wt %.

44. The method of claim 22 wherein the vehicle has a viscosity ranging from about 50 cPs to about 75 cPs at about 100 s⁻¹.

45. The method of claim 22 wherein the vehicle has a viscosity of about 68 cPs at about 100 s⁻¹.

46. The method of claim 22 wherein the formulation has a viscosity ranging from about 220 cPs to about 270 cPs at about 100 s⁻¹.

47. The method of claim 22 wherein the formulation has a viscosity of about 247 cPs at about 100 s⁻¹.

48. The method of claim 22 wherein the second thickness ranges from about 20 μm to about 150 μm.

49. A formulation for dip coating a superconducting coating onto a substrate, the formulation consisting essentially of:
about 63 wt % phase pure YBa₂Cu₃O₆₊ₓ powder and about 37 wt % vehicle,
the vehicle consisting essentially of
from about 57 wt % to about 59 wt % alpha-terpineol,
from about 37 wt % to about 39 wt % 2-butoxyethyl acetate,
from about 0.3 wt % to about 0.9 wt % B-67 acryloid,
from about 0.4 wt % to about 0.8 wt % T-200™ cellulose,
from about 0.5 wt % to about 0.9 wt % N4™ cellulose, and
from about 0.4 wt % to about 0.8 wt % Ehec-Hi™ cellulose.

50. The dip coating formulation of claim 49 wherein the formulation is free of dispersant.

51. The dip coating formulation of claim 49 wherein the vehicle comprises about 57.8 wt % alpha-terpineol.

52. The dip coating formulation of claim 49 wherein the vehicle comprises about 38.6 wt % 2-butoxyethyl acetate.

53. The dip coating formulation of claim 49 wherein the vehicle comprises about 1.6 wt % B-67 acryloid.

54. The dip coating formulation of claim 49 wherein the vehicle comprises 0.65 wt % T-200™ cellulose.

55. The dip coating formulation of claim 49 wherein the vehicle comprises 0.6 wt % Ehec-Hi™ cellulose.

56. The dip coating formulation of claim 49 wherein the vehicle comprises 0.7 wt % N4™ cellulose.

57. The dip coating formulation of claim 49 wherein the vehicle has a viscosity ranging from about 50 cPs to about 75 cPs at about 100 s⁻¹.

58. The dip coating formulation of claim 49 wherein the vehicle has a viscosity of about 68 cPs at about 100 s⁻¹.

59. The dip coating formulation of claim 49 wherein the formulation has a viscosity ranging from about 220 cPs to about 270 cPs at about 100 s⁻¹.

60. The dip coating formulation of claim 49 wherein the formulation has a viscosity of about 247 cPs at about 100 s⁻¹.

61. A method for applying a superconducting coating onto a substrate by dip coating, the method comprising:
providing a substrate with a first thickness;
providing a vehicle consisting essentially of
from about 57 wt % to about 59 wt % alpha-terpineol,
from about 37 wt % to about 39 wt % 2-butoxyethyl acetate,
from about 0.3 wt % to about 0.9 wt % B-67 acryloid,
from about 0.4 wt % to about 0.8 wt % T-200™ cellulose,
from about 0.5 wt % to about 0.9 wt % N4™ cellulose, and
from about 0.4 wt % to about 0.8 wt % Ehec-Hi™ cellulose
mixing the vehicle with phase pure YBa₂Cu₃O₆₊ₓ powder to provide a dip coating formulation comprising about 63 wt % phase pure YBa₂Cu₃O₆₊ₓ powder and about 37 wt % vehicle and with a viscosity of about 247 cPs at 100s⁻¹;
dipping the substrate in the method form a coating thereon having a second thickness;
removing the substrate from the method;
drying the substrate; and
sintering the substrate.
